(19) United States
(12) Patent Application Publication
(10) Pub. No.: US 2025/0328554 A1
(43) Pub. Date: Oct. 23, 2025

(54) DYNAMIC SIMILARITY THRESHOLD SELECTION FOR NATURAL LANGUAGE CACHES

(71) Applicant: Cisco Technology, Inc., San Jose, CA (US)

(72) Inventors: Arun Kwangil Iyengar, Yorktown Heights, NY (US); Ashish Kundu, Milpitas, CA (US)

(73) Assignee: Cisco Technology, Inc., San Jose, CA (US)

(21) Appl. No.: 18/641,611

(22) Filed: Apr. 22, 2024

(51) Int. Cl. G06F 16/332

(52) U.S. Cl. CPC G06F 16/3329

(57) ABSTRACT

A device receives a query for input to a language model. The device then selects a particular similarity threshold based on information associated with the query. The device makes, using the particular similarity threshold, a determination as to whether the query matches a cached query. The device provides, based on the determination, a response associated with the cached query in lieu of inputting the query to the language model.

### TECHNICAL FIELD

The present disclosure relates generally to dynamic similarity threshold selection for natural language caches.

### BACKGROUND

The recent breakthroughs in large language models (LLMs), such as ChatGPT and GPT-4, represent new opportunities across a wide spectrum of industries. Indeed, the ability of these models to follow instructions now allow for interactions with tools (also called plugins) that are able to perform tasks such as searching the web, executing code, etc. In addition, LLMs are also able to interact with human users in a conversational manner to provide answers to highly technical and complex questions.

However, issuing queries to LLMs can be very resource intensive and time-consuming. Accordingly, recent efforts have shifted towards augmenting an LLM system with a caching mechanism that allows the system to first search a cache of existing question-answer pairs, only querying the LLM for answers to questions that do not match (or are sufficiently similar to) any of the questions stored in the cache. Doing so can significantly reduce the resource costs associated with querying the LLM itself.

Typically, LLM caches perform query matching using a static semantic similarity threshold. For instance, if a given query is 90% similar to that in the cache (or more), the system may return the corresponding answer from the cache. Otherwise, the system sends the query on to the LLM for an answer. This approach, though, is inflexible and ignores the fact that the similarity threshold that is needed for a given query is often a function of a number of different factors.

### BRIEF DESCRIPTION OF THE DRAWINGS

The implementations herein may be better understood by referring to the following description in conjunction with the accompanying drawings in which like reference numerals indicate identically or functionally similar elements, of which:

FIGS. 1A-1B illustrate an example communication network;

FIG. 2 illustrates an example network device;

FIG. 3 illustrates an example architecture for a large language model (LLM)-based agent for dynamic similarity threshold selection for natural language caches;

FIG. 4 illustrates an example of the interactions of the components of the architecture in FIG. 3;

FIG. 5 illustrates an example operating environment for dynamic similarity threshold selection for natural language caches;

FIGS. 6A-6B illustrate example user interfaces for dynamically setting a caching similarity threshold; and

FIG. 7 illustrates an example simplified procedure for dynamic similarity threshold selection for natural language caches.

### DESCRIPTION OF EXAMPLE IMPLEMENTATIONS

### Overview

According to one or more implementations of the disclosure, a device receives a query for input to a language model. The device then selects a particular similarity threshold based on an at least one of a user preference, a query type, a latency for receiving at least one response from the language model, a cost to make a query to the language model, and a level of network connectivity with the language model. The device makes, using the particular similarity threshold, a determination as to whether the query matches a cached query. The device provides, based on the determination, a response associated with the cached query in lieu of inputting the query to the language model.

### Description

A computer network is a geographically distributed collection of nodes interconnected by communication links and segments for transporting data between end nodes, such as personal computers and workstations, or other devices, such as sensors, etc. Many types of networks are available, with the types ranging from local area networks (LANs) to wide area networks (WANs). LANs typically connect the nodes over dedicated private communications links located in the same general physical location, such as a building or campus. WANs, on the other hand, typically connect geographically dispersed nodes over long-distance communications links, such as common carrier telephone lines, optical lightpaths, synchronous optical networks (SONET), or synchronous digital hierarchy (SDH) links, or Powerline Communications (PLC) such as IEEE 61334, IEEE P1901.2, and others. The Internet is an example of a WAN that connects disparate networks throughout the world, providing global communication between nodes on various networks. The nodes typically communicate over the network by exchanging discrete frames or packets of data according to predefined protocols, such as the Transmission Control Protocol/Internet Protocol (TCP/IP). In this context, a protocol consists of a set of rules defining how the nodes interact with each other. Computer networks may be further interconnected by an intermediate network node, such as a router, to extend the effective “size” of each network.

Smart object networks, such as sensor networks, in particular, are a specific type of network having spatially distributed autonomous devices such as sensors, actuators, etc., that cooperatively monitor physical or environmental conditions at different locations, such as, e.g., energy/power consumption, resource consumption (e.g., water/gas/etc. for advanced metering infrastructure or “AMI” applications) temperature, pressure, vibration, sound, radiation, motion, pollutants, etc. Other types of smart objects include actuators, e.g., responsible for turning on/off an engine or perform any other actions. Sensor networks, a type of smart object network, are typically shared-media networks, such as wireless or PLC networks. That is, in addition to one or more sensors, each sensor device (node) in a sensor network may generally be equipped with a radio transceiver or other communication port such as PLC, a microcontroller, and an energy source, such as a battery. Often, smart object networks are considered field area networks (FANs), neighborhood area networks (NANs), personal area networks (PANs), etc. Generally, size and cost constraints on smart object nodes (e.g., sensors) result in corresponding constraints on resources such as energy, memory, computational speed and bandwidth.

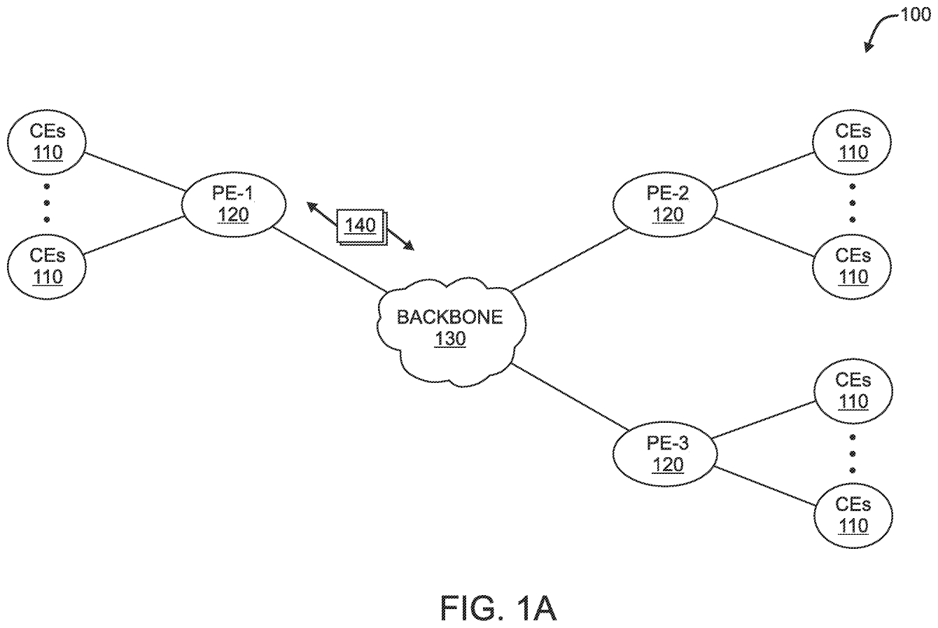

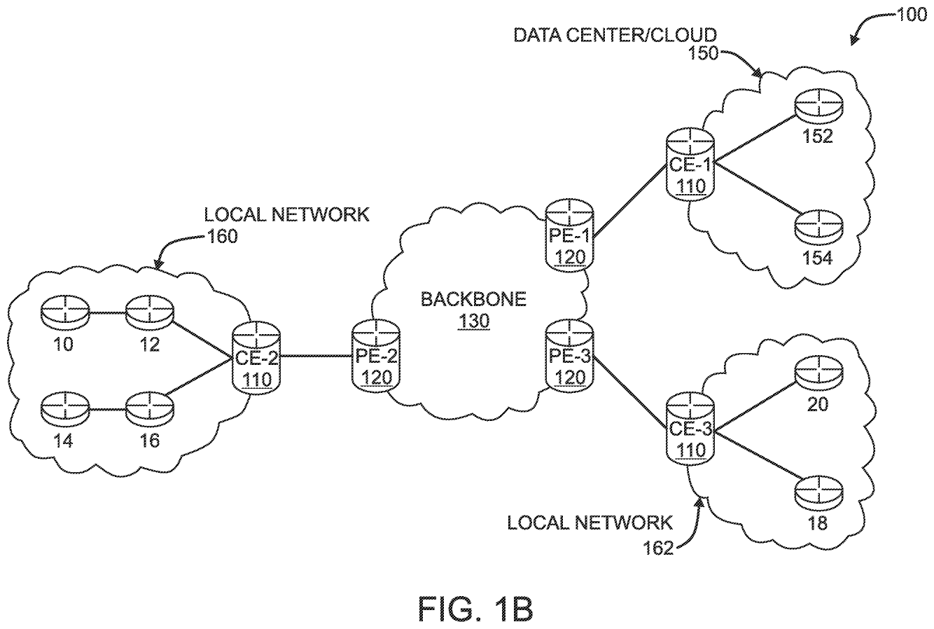

FIG. 1A is a schematic block diagram of an example computer network 100 illustratively comprising nodes/devices, such as a plurality of routers/devices interconnected by links or networks, as shown. For example, customer edge (CE) routers 110 may be interconnected with provider edge (PE) routers 120 (e.g., PE-1, PE-2, and PE-3) in order to communicate across a core network, such as an illustrative network backbone 130. For example, routers 110, 120 may be interconnected by the public Internet, a multiprotocol label switching (MPLS) virtual private network (VPN), or the like. Data packets 140 (e.g., traffic/messages) may be exchanged among the nodes/devices of computer network 100 over links using predefined network communication protocols such as the Transmission Control Protocol/Internet Protocol (TCP/IP), User Datagram Protocol (UDP), Asynchronous Transfer Mode (ATM) protocol, Frame Relay protocol, or any other suitable protocol. Those skilled in the art will understand that any number of nodes, devices, links, etc. may be used in the computer network, and that the view shown herein is for simplicity.

In some implementations, a router or a set of routers may be connected to a private network (e.g., dedicated leased lines, an optical network, etc.) or a virtual private network (VPN), such as an MPLS VPN thanks to a carrier network, via one or more links exhibiting very different network and service level agreement characteristics. For the sake of illustration, a given customer site may fall under any of the following categories:

1.) Site Type A: a site connected to the network (e.g., via a private or VPN link) using a single CE router and a single link, with potentially a backup link (e.g., a 3G/4G/5G/LTE backup connection). For example, a particular CE router 110 shown in network 100 may support a given customer site, potentially also with a backup link, such as a wireless connection.

2.) Site Type B: a site connected to the network by the CE router via two primary links (e.g., from different Service Providers), with potentially a backup link (e.g., a 3G/4G/5G/LTE connection). A site of type B may itself be of different types:

2a.) Site Type B1: a site connected to the network using two MPLS VPN links (e.g., from different Service Providers), with potentially a backup link (e.g., a 3G/4G/5G/LTE connection).

2b.) Site Type B2: a site connected to the network using one MPLS VPN link and one link connected to the public Internet, with potentially a backup link (e.g., a 3G/4G/5G/LTE connection). For example, a particular customer site may be connected to network 100 via PE-3 and via a separate Internet connection, potentially also with a wireless backup link.

2c.) Site Type B3: a site connected to the network using two links connected to the public Internet, with potentially a backup link (e.g., a 3G/4G/5G/LTE connection).

Notably, MPLS VPN links are usually tied to a committed service level agreement, whereas Internet links may either have no service level agreement at all or a loose service level agreement (e.g., a “Gold Package” Internet service connection that guarantees a certain level of performance to a customer site).

3.) Site Type C: a site of type B (e.g., types B1, B2 or B3) but with more than one CE router (e.g., a first CE router connected to one link while a second CE router is connected to the other link), and potentially a backup link (e.g., a wireless 3G/4G/5G/LTE backup link). For example, a particular customer site may include a first CE router 110 connected to PE-2 and a second CE router 110 connected to PE-3.

FIG. 1B illustrates an example of network 100 in greater detail, according to various implementations. As shown, network backbone 130 may provide connectivity between devices located in different geographical areas and/or different types of local networks. For example, network 100 may comprise local/branch networks 160, 162 that include devices/nodes 10-16 and devices/nodes 18-20, respectively, as well as a data center/cloud environment 150 that includes servers 152-154. Notably, local networks 160-162 and data center/cloud environment 150 may be located in different geographic locations.

Servers 152-154 may include, in various implementations, a network management server (NMS), a dynamic host configuration protocol (DHCP) server, a constrained application protocol (CoAP) server, an outage management system (OMS), an application policy infrastructure controller (APIC), an application server, etc. As would be appreciated, network 100 may include any number of local networks, data centers, cloud environments, devices/nodes, servers, etc.

In some implementations, the techniques herein may be applied to other network topologies and configurations. For example, the techniques herein may be applied to peering points with high-speed links, data centers, etc.

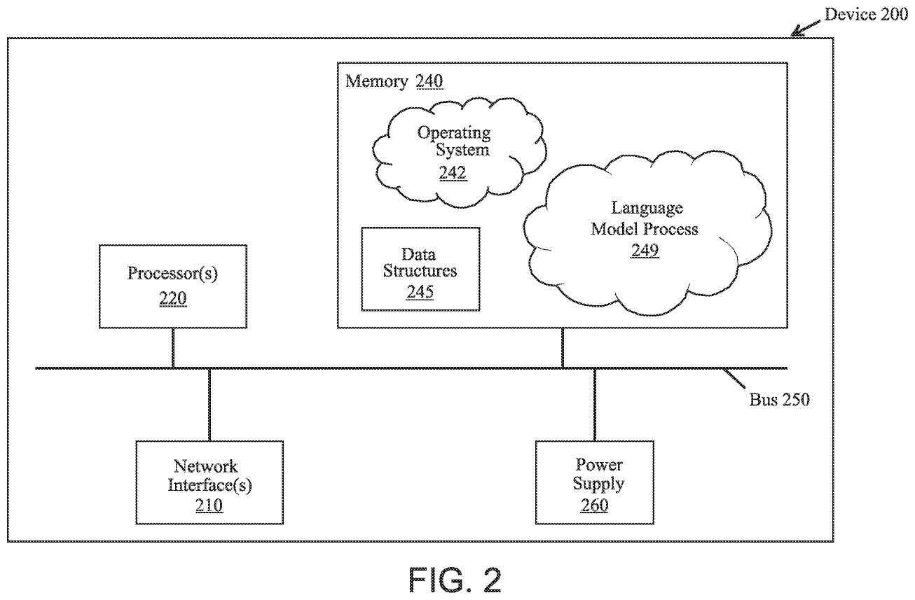

FIG. 2 is a schematic block diagram of an example node/device 200 (e.g., an apparatus) that may be used with one or more implementations described herein, e.g., as any of the computing devices shown in FIGS. 1A-1B, particularly the PE routers 120, CE routers 110, nodes/device 10-20, servers 152-154 (e.g., a network controller/supervisory service located in a data center, etc.), any other computing device that supports the operations of network 100 (e.g., switches, etc.), or any of the other devices referenced below. Device 200 may also be any other suitable type of device depending upon the type of network architecture in place, such as IoT nodes, etc. Device 200 comprises one or more network interfaces 210, one or more processors 220, and a memory 240 interconnected by a system bus 250, and is powered by a power supply 260.

Network interfaces 210 include the mechanical, electrical, and signaling circuitry for communicating data over physical links coupled to network 100. Network interfaces 210 may be configured to transmit and/or receive data using a variety of different communication protocols. Notably, a physical network interface 210 may also be used to implement one or more virtual network interfaces, such as for virtual private network (VPN) access, known to those skilled in the art.

Memory 240 comprises a plurality of storage locations that are addressable by processor(s) 220 and network interfaces 210 for storing software programs and data structures associated with the implementations described herein. Processor 220 may comprise necessary elements or logic adapted to execute the software programs and manipulate data structures 245. An operating system 242 (e.g., the Internetworking Operating System, or IOS®, of Cisco Systems, Inc., another operating system, etc.), portions of which are typically resident in memory 240 and executed by the processor(s), functionally organizes the node by, inter alia, invoking network operations in support of software processors and/or services executing on the device. These software components may comprise a language model process 249 as described herein, any of which may alternatively be located within individual network interfaces.

It will be apparent to those skilled in the art that other processor and memory types, including various computer-readable media, may be used to store and execute program instructions pertaining to the techniques described herein. Also, while the description illustrates various processes, it is expressly contemplated that various processes may be embodied as modules configured to operate in accordance with the techniques herein (e.g., according to the functionality of a similar process). Further, while processes may be shown and/or described separately, those skilled in the art will appreciate that processes may be routines or modules within other processes.

In various implementations, as detailed further below, language model process 249 may include computer executable instructions that, when executed by processor(s) 220, cause device 200 to perform the techniques described herein. To do so, in some implementations, language model process 249 may utilize machine learning. In general, machine learning is concerned with the design and the development of techniques that take as input empirical data (such as network statistics and performance indicators), and recognize complex patterns in these data. One very common pattern among machine learning techniques is the use of an underlying model M, whose parameters are optimized for minimizing the cost function associated to M, given the input data. For instance, in the context of classification, the model M may be a straight line that separates the data into two classes (e.g., labels) such that M=a*x+b*y+c and the cost function would be the number of misclassified points. The learning process then operates by adjusting the parameters a,b,c such that the number of misclassified points is minimal. After this optimization phase (or learning phase), the model M can be used very easily to classify new data points. Often, M is a statistical model, and the cost function is inversely proportional to the likelihood of M, given the input data.

In various implementations, language model process 249 may employ one or more supervised, unsupervised, or semi-supervised machine learning models. Generally, supervised learning entails the use of a training set of data, as noted above, that is used to train the model to apply labels to the input data. For example, the training data may include sample telemetry that has been labeled as being indicative of an acceptable performance or unacceptable performance. On the other end of the spectrum are unsupervised techniques that do not require a training set of labels. Notably, while a supervised learning model may look for previously seen patterns that have been labeled as such, an unsupervised model may instead look to whether there are sudden changes or patterns in the behavior of the metrics. Semi-supervised learning models take a middle ground approach that uses a greatly reduced set of labeled training data.

Example machine learning techniques that language model process 249 can employ may include, but are not limited to, nearest neighbor (NN) techniques (e.g., k-NN models, replicator NN models, etc.), statistical techniques (e.g., Bayesian networks, etc.), clustering techniques (e.g., k-means, mean-shift, etc.), neural networks (e.g., reservoir networks, artificial neural networks, etc.), support vector machines (SVMs), generative adversarial networks (GANs), long short-term memory (LSTM), logistic or other regression, Markov models or chains, principal component analysis (PCA) (e.g., for linear models), singular value decomposition (SVD), multi-layer perceptron (MLP) artificial neural networks (ANNs) (e.g., for non-linear models), replicating reservoir networks (e.g., for non-linear models, typically for timeseries), random forest classification, or the like.

In further implementations, language model process 249 may also include one or more generative artificial intelligence/machine learning models. In contrast to discriminative models that simply seek to perform pattern matching for purposes such as anomaly detection, classification, or the like, generative approaches instead seek to generate new content or other data (e.g., audio, video/images, text, etc.), based on an existing body of training data. Example generative approaches can include, but are not limited to, generative adversarial networks (GANs), large language models (LLMs), other transformer models, and the like.

As noted above, efforts have shifted towards augmenting an LLM system with a caching mechanism that allows the system to first search a cache of existing question-answer pairs, only querying the LLM for answers to questions that do not match (or are sufficiently similar to) those questions stored in the cache. LLM caches, however, perform query matching using a static semantic similarity threshold. For instance, if a given query is 90% similar to that in the cache (or more), the system may return the corresponding answer from the LLM cache. Otherwise, the system may query the LLM for the answer. This approach, though, is inflexible and ignores the fact that the semantic similarity threshold that is needed for a given query is often a function of a number of different factors. In addition, the semantic similarity threshold is inexact. If the level of similarity expected by the system is too high, the cache hit rate will be low, ignoring cached objects. If the level of similarity expected by the system is too low, the cache can return irrelevant content to satisfy a query.

In addition, generative AI systems like ChatGPT and Google Bard can have high latency. If many queries are being made, the overhead and time delay for responses can be considerable. Caching the results of queries can improve performance considerably. It can also reduce monetary costs for LLM queries, as well as reduce computational costs on servers providing LLM content.

### Dynamic Similarity Threshold selection for LLM Caches

The techniques herein provide for a flexible thresholding mechanism for LLM caches that dynamically adapts to the needs of a given use case.

Illustratively, the techniques described herein may be performed by hardware, software, and/or firmware, such as in accordance with language model process 249, which may include computer executable instructions executed by the processor 220 (or independent processor of interfaces 210) to perform functions relating to the techniques described herein.

Specifically, according to various implementations, a device receives a query for input to a language model. The device then selects a particular similarity threshold based on at least one of a user preference, a query type, a latency for receiving at least one response from the language model, a cost to make a query to the language model, and a level of network connectivity with the language model. The device makes, using the particular similarity threshold, a determination as to whether the query matches a cached query. The device provides, based on the determination, a response associated with the cached query in lieu of inputting the query to the language model.

Operationally, the disclosure provides techniques for selecting the semantic similarity threshold for determining a matching query from a LLM cache based on a number of factors. Furthermore, disclosure provides for the semantic similarity threshold to be varied dynamically. The semantic similarity threshold can be varied based on a number of criteria, including but not limited to user preferences for how close a semantic match is desired. The criteria for selecting and/or varying the semantic similarity threshold for query matching may include one or more of user preferences, nature of an application associated with the query, a latency for satisfying the query from the language model, a cost for contacting the language model, and a network connectivity between a user device and a server hosting the language model.

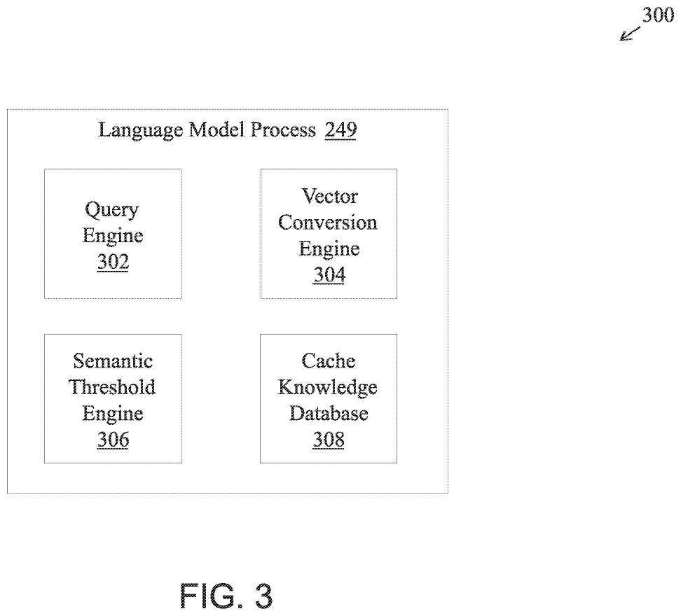

FIG. 3 illustrates an example architecture 300 for using a large language model (LLM)-based agent for dynamic similarity threshold selection for LLM caches, according to various implementations. At the core of architecture 300 is language model process 249, which may be executed at a user device, a CE router, a PE router, a server, or another device in communication with. Language model process 249 may interface with a user device, either locally or via a network, such as via one or more application programming interfaces (APIs), etc. In addition, language model process 249 may communicate with any number of user interfaces.

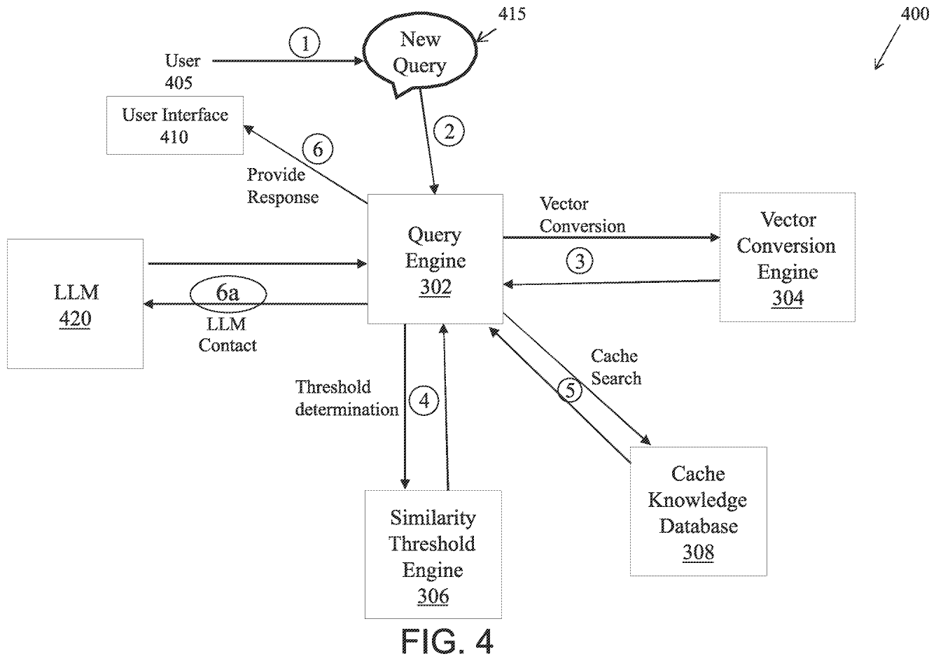

As shown, language model process 249 may include any or all of the following components: a query engine 302, a vector conversion engine 304, a semantic threshold engine 306, and a cache knowledge database 308. As would be appreciated, the functionalities of these components may be combined or omitted, as desired. In addition, these components may be implemented on a singular device or in a distributed manner, in which case the combination of executing devices can be viewed as their own singular device for purposes of executing language model process 249. FIG. 4 illustrates an example 400 of the interactions of the components of architecture 300.

According to various implementations, query engine 302 may receive a query from a user, run one or more steps that can include retrieving a response from a LLM cache or calling an LLM for the response, and providing a response to the query. Thus, query engine 302 may leverage one or more LLMs and/or a query cache to provide a response to a query received from a user. As discussed in a greater detail in the following sections of the disclosure, query engine 302 may use a dynamic semantic similarity threshold to provide a response to the query.

In various implementations, vector conversion engine 304 may convert the query received from the user in a natural language to a vector. Vector conversion engine 304 may use a variety of different models to convert or to vectorize the query to a vector v1. Such models may include but are not limited to proprietary models, publicly available models from organizations such as Hugging Face and OpenAI, and other open-source models.

According to various implementations, cache knowledge database 308 may include a vector database for efficiently comparing queries embedded as vectors. At least one other data store, which could be a key-value store, can be used for storing a query-response pair. Cache knowledge database 308 may facilitate semantic searches of stored query-response pairs. In examples, cache knowledge database 308 may leverage a vector database such as Chroma or Pinecone to achieve this role.

In various implementations, semantic threshold engine 306 may determine a particular similarity threshold for searching for a response for a query in cache knowledge database 308. The semantic similarity threshold is based on a number of factors and can be varied dynamically. In example implementations, the semantic similarity threshold is determined and varied based on a number of criteria, including but not limited to user preferences for how close a semantic match is desired. For example, if the level of similarity expected by the semantic similarity threshold is too high, the cache hit rate will be low, ignoring cached objects. If the level of similarity expected by the semantic similarity threshold is too low, the cache can return irrelevant content to satisfy a query.

For example, a similarity threshold of 0.5 may be determined to be a good choice for similarity metrics such as a cosine similarity. The queries “What is an application-level denial of service attack?” and “What are the major types of cyber attacks?” are considerably different. However, a cosine similarity has been determined as 0.55 between these two queries using the Facebook contriever-msmarco model, exceeding the 0.5 threshold. Similarly, the cosine similarity between “What is an application-level denial of service attack?” and “How do denial of service attacks work?” is even higher at. 0.75. However, these two queries are considerably different. The former is asking about a specific type of denial of service attack while the latter is asking about denial of service attacks in general. The answers to these two queries would be expected to differ considerably, and a cached answer for the first query may not be used to satisfy the second query (or vice versa).

Thus, a rigid once size fits all values for the semantic similarity threshold may not be sufficient. Therefore, the semantic similarity threshold is determined based on a number of factors and can be varied dynamically. For example, semantic threshold engine 306 provides avenues to vary the way in which the semantic similarity threshold is determined in order to better match the queries and user preferences. Some example factors that are considered to determine the semantic similarity threshold include:
Type of query: some queries may tolerate low semantic similarity thresholds, while others may require higher semantic similarity thresholds.
Type of application associated with the query: some applications may require more stringent matching than others. For example, LLMs can be used to generate computer code in languages such as Python, Java, C, C++, JavaScript, and several other computer languages. When users make queries to LLMs to generate computer code, the queries need to be precise to generate correct code. Therefore, it may be desirable to have a high semantic similarity threshold for queries requesting computer code compared with queries for other types of content such as natural language. For example, when caching computer code, a semantic similarity threshold equal or close to 1.0 could be used, where 1.0 indicates a perfect match. When caching natural language, a lower semantic similarity could be used.
Latency considerations: during certain periods, it may take a considerable time for a query to be satisfied by an LLM. When latencies are high, it may be preferable to have a lower semantic similarity threshold to increase cache hit rate. Some applications are more latency sensitive than others. Those more latency sensitive applications may also use a lower semantic similarity threshold to increase cache hit rates.
Resource considerations: in some cases, queries to LLMs and other natural language understanding services may cost money or consume other such resources. Satisfying queries from a cache avoids these resource costs and lowering the similarity threshold may help to reduce resource consumption.
Network performance: a client computer may lose connectivity with an LLM or natural language understanding service. Accessing data from the cache may allow an application on such client computer to function in the event of poor connectivity. Therefore, when a client computer loses connectivity or has poor connectivity, the semantic similarity threshold may be lowered to allow the application to function despite the poor connectivity. More generally, the threshold may be selected based on the performance of the network, such as its packet loss, latency, jitter, etc.
User preferences: a user can specify, as well as change, a semantic similarity threshold.

Thus, multiple characteristics and properties may be used to set an appropriate value for the semantic similarity threshold, for example, a user preference, a nature of the application, a latency for satisfying query, a cost for the query, and a network connectivity. The semantic similarity threshold, therefore, can be different for different queries, different users, the same query from different users, the same query from the same user from different networks, etc. In some examples, a learning model may be employed to determine the semantic similarity threshold based on the abovementioned multiple characteristics and properties.

In various implementations, parameters for selecting the semantic similarity threshold may be received from a user through a user interface. For example, a user can specify the semantic similarity threshold for a query to be selected based on monetary considerations and/or latency satisfying query. In some other implementations, a user can define a weight for each parameter for selecting the semantic similarity threshold. Semantic threshold engine 306 may factor such user inputs when determining the semantic similarity threshold.

FIG. 4 illustrates an example 400 of the interactions of the components of the architecture in FIG. 3. As shown, a user 405 may create a new query 415 via a user interface 410, as shown at (1). New query 415 is sent from user interface 410 to query engine 302, as shown at (2). New query 415 may be in a natural language, for example:
“What is a status of a CE router in computer network 100?”
“What is an application-level denial of service attack?”
“How do denial of service attacks work?”
“What are the major types of cyber-attacks?”
“Explain how random forests can be used for regression and classification problems” or
“I need to perform regression and classification on certain data sets. I have heard that random forests are a potential approach. How can I apply random forests for what I am trying to do?”

In further embodiments, an application may generate new query 415 automatically, instead of being specified by user 405. In example implementations, user interface 410 may include application program interfaces.

Vector conversion engine 304 may then convert new query 415 from natural language format into a vector v1, in some embodiments Query engine 302 may receive the vector v1 corresponding to new query 415 from vector conversion engine 304, shown at (3). As discussed above, vector conversion engine 304 may use a variety of different models to convert new query 415 to the vector v1. An example may include the Facebook Contriever MSMARCO model.

As shown at (4), similarity threshold engine 306 may determine a similarity threshold for new query 415, such as based on information associated with it. In various cases, semantic threshold engine 306 may select the similarity threshold for use by query engine 302 based on information associated with new query 415 such as, but not limited to, a user preference, a query type, a nature of an application associated with new query 415 (e.g., the application via which new query 415 was generated), a latency associated with asking a language model, such as LLM 420, to answer new query 415, a level of network performance associated with the network via which query engine 302 communicates with at least one LLM 420, or the like.

At (5), query engine 302 may then perform a search in cache knowledge database 308 for the vector v1, to identify a cached query associated with a vector v2 that is similar to vector v1, based on the selected semantic similarity threshold. One example approach for determining if there is a cached query similar to new query 415 is to compare the vector v1 to all vectors stored in cache knowledge database 308. In various implementations, query engine 302 may do so by comparing their cosine similarity, dot product, Euclidean distance, Manhattan distance, Minkowski distance (a generalization of Euclidean and Manhattan distance), or any other suitable comparison measure. While this method might be fine if cache knowledge database 308 does not contain too many vectors, when there are many vectors, the one-to-one comparison may become inefficient. Indeed, the one-to-one comparison takes O(n) execution time where n is the number of cached query-answer pairs in cache knowledge database 308. Other more efficient ways exist for comparing vectors that query engine 302 could also use, and several are available as open-source libraries, such as Faiss and the like.

During its comparison, query engine 302 may identify the most similar vector v2 stored in cache knowledge database 308. Query engine 302 then determines whether the measure of similarity between vector v1 and vector v2 exceeds the semantic similarity threshold. If the answer is yes, then query engine 302 returns the cached answer associated with the cached query that is represented as vector v2 as the answer to the new query 415, as shown at (6). The cached answer is provided to user 405 via user interface 410.

However, if the level of similarity between the vector v1 and a vector v2 does not exceed the similarity threshold, then query engine 302 may send new query 415 to LLM 420 to satisfy new query 415, as shown at (6a). The response received from the at least one LLM 420 is then provided to user 405 over the user interface 410. An entry for the response received from the at least one LLM 420 may be created in cache knowledge database 308.

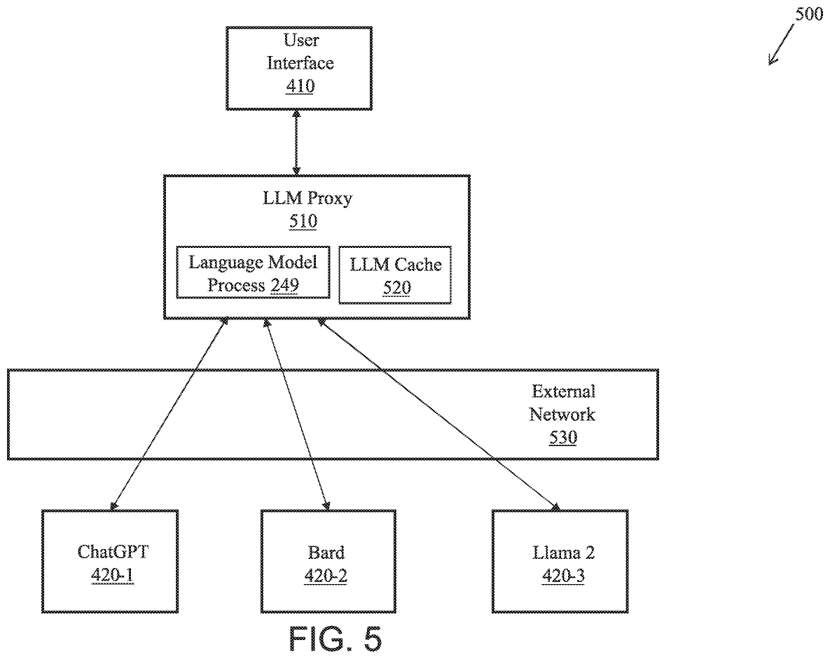

FIG. 5 illustrates an example operating environment 500 for dynamic similarity threshold selection for LLM caches, in accordance with one or more implementations described herein. As shown, operating environment 500 includes user interface 410, a LLM proxy 510, an external network 530, and a plurality of LLMs, that is, ChatGPT 420-1, Bard 420-2, and Llama 2 420-3. Although only three LLMs are shown, operating environment 500 may include a different number of LLMs. LLM proxy 510 may include language model process 249 and an LLM cache 520.

LLMs such as ChatGPT 420-1, Bard 420-2, and Llama 2 420-3 are examples of query answering services. Query answering services accept natural language queries and provide a response to the natural language queries. Search engines, such as Google and Bing, are other examples of query answering services. Chatbots can also function as query answering services.

User interface 410 may be provided on a user device, for example, one or more of nodes/device 10-20. As discussed above, user 405 may create new query 415 on user interface 410. New query 415 is received by LLM proxy 510. LLM proxy 510 may be provided on any of nodes/device 10-20, CE routers 110, and PE routers 120. LLM proxy 510, using language model process 249, may convert new query 415 to the vector v1 and perform a search in LLM cache 520 to determine a cached query that is associated with a vector v2 that is most similar to vector v1. LLM proxy 510 determines whether a semantic similarity between the vector v1 and the vector v2 exceeds the semantic similarity threshold. If the answer is yes, then LLM proxy 510 returns the cached answer corresponding to new query 415 to user interface 410. If the semantic similarity between the vector v1 and the vector v2 does not exceed the semantic similarity threshold, then LLM proxy 510 contacts at least one of the plurality of LLMs (that is, ChatGPT 420-1, Bard 420-2, or Llama 2 420-3) over external network 530.

LLM proxy 510 may be able to contact one or more of the plurality of LLMs through external network 530 over links using predefined network communication protocols such as the Transmission Control Protocol/Internet Protocol (TCP/IP), User Datagram Protocol (UDP), Asynchronous Transfer Mode (ATM) protocol, Frame Relay protocol, or any other suitable protocol. External network 530 may include the public Internet, a multiprotocol label switching (MPLS) virtual private network (VPN), or the like.

LLM proxy 510 may receive a response for new query 415 from one or more of the plurality of LLMs (that is, ChatGPT 420-1, Bard 420-2, or Llama 2 420-3). LLM proxy 510 may provide the received response to user interface 410 to satisfy new query 415. In some examples, LLM proxy 510 may cache the response for new query 415 received from one or more of the plurality of LLMs in LLM cache 520.

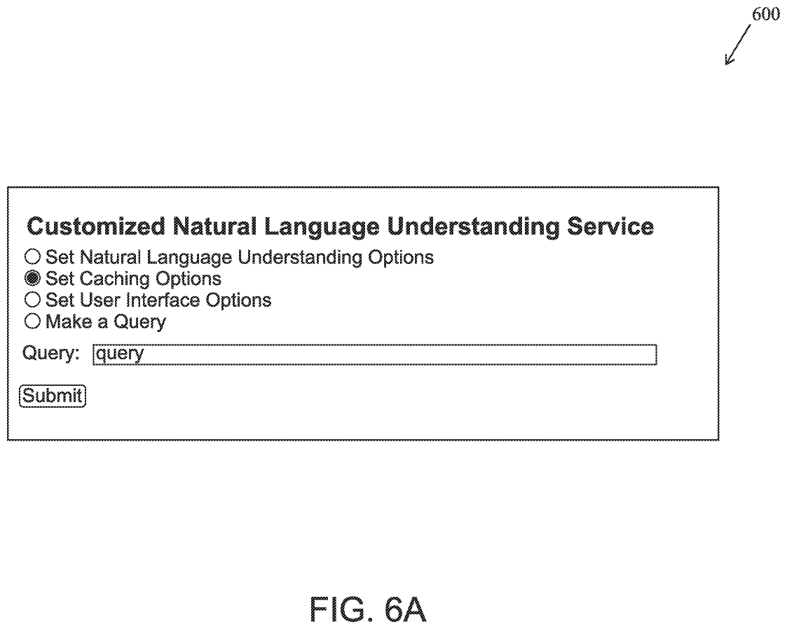

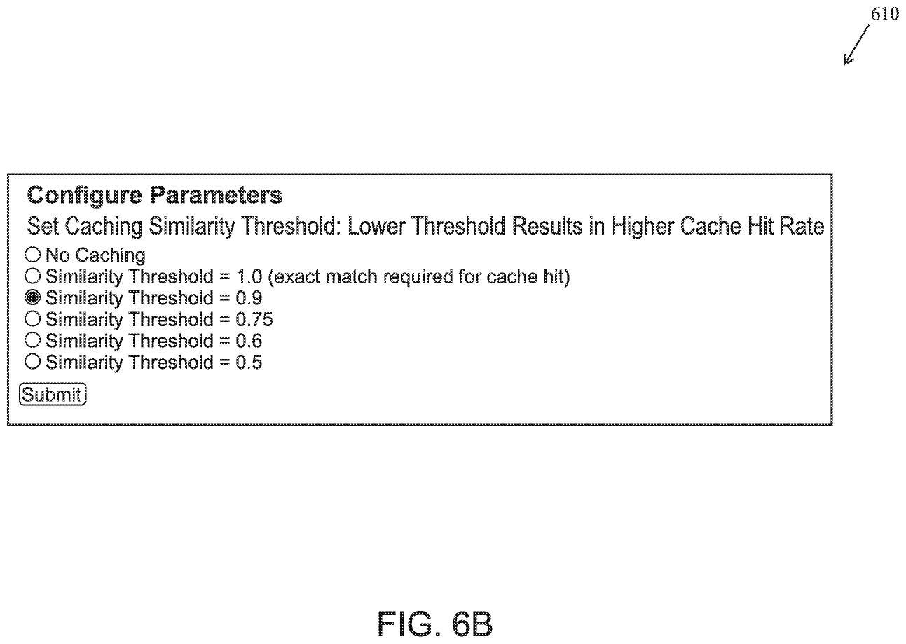

FIGS. 6A-6B illustrate example user interfaces for dynamically setting a caching similarity threshold, according to various embodiments. As shown in screen capture 600 in FIG. 6A, the system may present the user with a user interface that has various options, including the ability to set the caching options of the system. When selected, the user may be presented with the user interface in screen shot 610 in FIG. 6B. Using this, the user may opt for a specific semantic similarity threshold when performing a query. The user interface may also remind the user that lowering the threshold will increase the cache hit rate.

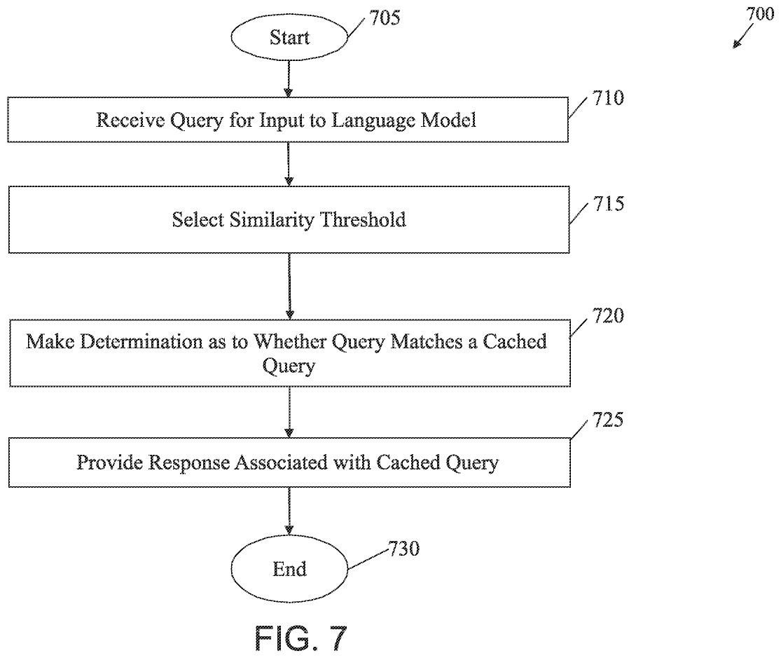

FIG. 7 illustrates an example simplified procedure (e.g., a method) for dynamic similarity threshold selection for LLM caches, in accordance with one or more implementations described herein. For example, a non-generic, specifically configured device (e.g., device 200), such as a router, firewall, controller for a network (e.g., an SDN controller or other device in communication therewith), server, or the like, may perform procedure 700 by executing stored instructions (e.g., language model process 249). Procedure 700 can also be performed by one or more general-purpose computers, including but not limited to cloud servers and virtual machines. The procedure 700 may start at step 705, and continues to step 710, where, as described in greater detail above, the device may receive a query for input to a language model. In some cases, the language model is a large language model (LLM) that the device accesses via an application programming interface (API).

At step 715, as detailed above, the device may select a particular similarity threshold based on information associated with the query. In one implementation, the information associated with the query indicates a query type associated with the query. For instance, a query for critical or sensitive information may require almost a perfect match when searching for a cached answer versus a less critical query. In another implementation, the information associated with the query indicates a latency associated with sending the query to the language model to produce an output. In a further implementation, the information associated with the query indicates a level of performance associated with a computer network via which the device accesses the language model (e.g., network latency, packet loss, etc.). In another implementation, the information associated with the query indicates a threshold parameter received from a user interface. In an additional implementation, the information associated with the query indicates a resource cost associated with sending the query to the language model to produce an output (e.g., a processing cost for at least one computer to generate a response to the query, etc.). In another implementation, the information associated with the query indicates an application via which the query was generated. In some cases, the application generated the query automatically.

At step 720, the device may make, using the particular similarity threshold, a determination as to whether the query matches a cached query, as described in greater detail above. In various implementations, the device may do so by determining whether a semantic distance between the query and the cached query exceeds the particular similarity threshold.

At step 725, as detailed above, the device may provide, based on the determination, a response associated with the cached query in lieu of inputting the query to the language model.

Procedure 700 then ends at step 730.

It should be noted that while certain steps within procedure 700 may be optional as described above, the steps shown in FIG. 7 are merely examples for illustration, and certain other steps may be included or excluded as desired. Further, while a particular order of the steps is shown, this ordering is merely illustrative, and any suitable arrangement of the steps may be utilized without departing from the scope of the implementations herein.

In accordance with example implementations, a method for improving response times to a query answering service, the query answering service providing natural language responses to queries, includes steps of: storing the queries made to the query answering service and corresponding responses from the query answering service in a cache; determining a semantic similarity threshold using at least one of a user preference, a query type, a latency for receiving at least one response from the query answering service, a cost to make a query to the query answering service, and a level of network connectivity with the query answering service, wherein the semantic similarity threshold is correlated with a level of semantic similarity between two natural language texts; receiving a query q1 at a device; determining a semantic similarity between the query q1 and at least one query q2 stored in the cache; and in response to determining at least one query q2 stored in the cache for which the semantic similarity between the query q1 and the at least one query q2 is greater than or equal to the semantic similarity threshold, returning a response r1 stored in the cache corresponding to the at least one query q2.

The method may further include, in response to failing to determine the at least one query q2 stored in the cache for which the semantic similarity between the query q1 and the at least one query q2 is greater than or equal to the semantic similarity threshold, returning a response r2 obtained by sending the query q1 to the query answering service.

The semantic similarity threshold is dynamically modified based on at least one of the user preference, the query type, the latency for receiving at least one response from the query answering service, the cost to make a query to the query answering service, and the level of network connectivity with the query answering service.

Determining the semantic similarity between the query q1 and the at least one query q2 may include computing a vector corresponding to each of the query q1 and the at least one query q2 being compared and determining the semantic similarity by comparing vectors.

The method may further include, in response to determining that the at least one query q2 stored in the cache for which the semantic similarity between the query q1 and the at least one query q2 is greater than or equal to the semantic similarity threshold, returning a response r1 stored in the cache, the semantic similarity between the query q1 and the at least one query q2 stored in the cache corresponding to the response r1 being a maximum value for all cached queries compared with the query q1.

While there have been shown and described illustrative implementations that provide for dynamic similarity threshold selection for LLM caches, it is to be understood that various other adaptations and modifications may be made within the spirit and scope of the implementations herein. For example, while certain protocols and types of language models are shown, other suitable protocols may be used, accordingly.

The foregoing description has been directed to specific implementations. It will be apparent, however, that other variations and modifications may be made to the described implementations, with the attainment of some or all of their advantages. For instance, it is expressly contemplated that the components and/or elements described herein can be implemented as software being stored on a tangible (non-transitory) computer-readable medium (e.g., disks/CDs/RAM/EEPROM/etc.) having program instructions executing on a computer, hardware, firmware, or a combination thereof. Accordingly, this description is to be taken only by way of example and not to otherwise limit the scope of the implementations herein. Therefore, it is the object of the appended claims to cover all such variations and modifications as come within the true spirit and scope of the implementations herein.

1. A method comprising:
receiving, at a device, a query for input to a language model;
selecting, by the device, a particular similarity threshold based on information including at least one of: a user preference, a query type, a latency for receiving at least one response from the language model, a cost to make a query to the language model, or a level of network connectivity with the language model;
making, by the device and using the particular similarity threshold, a determination as to whether the query matches a cached query for which the language model previously issued a response; and
providing, by the device and based on the determination, the response associated with the cached query in lieu of inputting the query to the language model.

2. The method as in claim 1, further comprising:
selecting the particular similarity threshold further based on a threshold parameter received from a user interface.

3. The method of claim 1, wherein the information associated with the query indicates an application via which the query was generated.

4. The method as in claim 3, wherein the application generated the query automatically.

5. The method as in claim 1, wherein making the determination as to whether the query matches the cached query comprises:
determining whether a semantic distance between the query and the cached query exceeds the particular similarity threshold.

6. The method as in claim 1, wherein the language model is a large language model (LLM) that the device accesses via an application programming interface (API).

7. An apparatus, comprising:
one or more network interfaces;
a processor coupled to the one or more network interfaces and configured to execute one or more processes; and
a memory configured to store a process that is executable by the processor, the process when executed configured to:
receive a query for input to a language model;
select a particular similarity threshold based on information associated with the query;
make, using the particular similarity threshold, a determination as to whether the query matches a cached query for which the language model previously issued a response; and
provide, based on the determination, the response associated with the cached query in lieu of inputting the query to the language model.

8. The apparatus as in claim 7, wherein the information associated with the query indicates a query type associated with the query.

9. The apparatus as in claim 7, wherein the information associated with the query indicates a latency associated with sending the query to the language model to produce an output.

10. The apparatus as in claim 7, wherein the information associated with the query indicates a level of performance associated with a computer network via which the apparatus accesses the language model.

11. The apparatus as in claim 7, wherein the information associated with the query indicates a threshold parameter received from a user interface.

12. The apparatus as in claim 7, wherein the information associated with the query indicates a resource cost associated with sending the query to the language model to produce an output.

13. The apparatus as in claim 7, wherein the information associated with the query indicates an application via which the query was generated.

14. The apparatus as in claim 13, wherein the application generated the query automatically.

15. The apparatus as in claim 7, wherein the apparatus makes the determination as to whether the query matches the cached query by:
determining whether a semantic distance between the query and the cached query exceeds the particular similarity threshold.

16. A method for improving response times to a query answering service, wherein the query answering service provides natural language responses to queries, the method comprising steps of:
storing the queries made to the query answering service and corresponding responses from the query answering service in a cache;
determining a semantic similarity threshold using at least one of a user preference, a query type, a latency for receiving at least one response from the query answering service, a cost to make a query to the query answering service, or a level of network connectivity with the query answering service, wherein the semantic similarity threshold is correlated with a level of semantic similarity between two natural language texts;
receiving a query q1 at a device;
determining a semantic similarity between the query q1 and at least one query q2 stored in the cache for which the query answering service previously issued a response r1; and
in response to determining at least one query q2 stored in the cache for which the semantic similarity between the query q1 and the at least one query q2 is greater than or equal to the semantic similarity threshold, returning the response r1 stored in the cache corresponding to the at least one query q2.

17. The method as in claim 16, further comprising:
in response to failing to determine the at least one query q2 stored in the cache for which the semantic similarity between the query q1 and the at least one query q2 is greater than or equal to the semantic similarity threshold, returning a response r2 obtained by sending the query q1 to the query answering service.

18. The method as in claim 16, wherein the semantic similarity threshold is dynamically modified based on at least one of the user preference, the query type, the latency for receiving at least one response from the query answering service, the cost to make a query to the query answering service, and the level of network connectivity with the query answering service.

19. The method as in claim 16, wherein determining the semantic similarity between the query q1 and the at least one query q2 comprises:
computing a vector corresponding to each of the query q1 and the at least one query q2 being compared; and
determining the semantic similarity by comparing vectors.

20. The method as in claim 16, further comprising:
in response to determining that the at least one query q2 stored in the cache for which the semantic similarity between the query q1 and the at least one query q2 is greater than or equal to the semantic similarity threshold, returning a response r1 stored in the cache, wherein the semantic similarity between the query q1 and the at least one query q2 stored in the cache corresponding to the response r1 is a maximum value for all cached queries compared with the query q1.
